(19) United States
(12) Patent Application Publication
(10) Pub. No.: US 2010/0281501 A1
(43) Pub. Date: Nov. 4, 2010

(54) SYSTEM AND METHOD FOR DELIVERING SERVICE GUIDE INFORMATION

(75) Inventors: Petri Paavola, Helsinki (FI); Martin Jansky, Espoo (FI); Topi-Oskari Pohjolainen, Helsinki (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/602,591

(22) PCT Filed: May 29, 2008
(86) PCT No.: PCT/IB08/52104

§ 371 Date: Jun. 30, 2010

Related U.S. Application Data
(60) Provisional application No. 60/941,631, filed on Jun. 1, 2007.

(51) Int. Cl. H04N 5/445

(52) U.S. Cl. 725/39

(57) ABSTRACT

A system and method for providing Electronic Service Guide (ESG) information to one or more terminals. Sliding time windows are used in a hierarchical fashion in order to prioritize file delivery sessions. In this arrangement, file delivery sessions representing a first interval of the hierarchy are extended to cover a longer interval whenever the interval becomes obsolete, i.e., when the end point of the interval becomes a point in the past before the current time. The end point of the first interval is extended beyond the current time by creating one or more subsequent intervals in the hierarchy. When a session is dropped, a new session is introduced at the end of the hierarchy. Various embodiments also provide a mechanism by which bandwidth can be allocated so that more bandwidth is provided to desired portions of the ESG.

### FIELD OF THE INVENTION

This present invention relates to electronic service guides (ESGs). More particularly, the present invention relates to the transmission of ESG information to one or more intended recipients.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

ESGs enable a terminal to communicate available services to end users and to indicate how such services may be accessed. ESGs serve to provide users with information regarding a variety of scheduled programs, allowing a user to navigate, select, and discover content by time, title, channel, genre, etc.

ESG fragments are independently-existing pieces of the ESG. ESG fragments can comprise XML documents, Session Description Protocol (SDP) descriptions, textual files, images and other items. ESG fragments describe one or several aspects of currently available services, future services or broadcast programs. Such aspects may include, for example, free text descriptions, schedules, geographical availability information, prices, purchase methods, genres, and supplementary information such as preview images or clips. Audio, video and other types of data comprising the ESG fragments may be transmitted through a variety of types of networks according to many different protocols. For example, data can be transmitted through the Internet using protocols of the Internet protocol suite, such as Internet Protocol (IP) and User Datagram Protocol (UDP). Data is often transmitted through the Internet addressed to a single user. The data can, however, be multicast (to a set of users) or broadcast to all users in an area.

In an ESG, information is typically presented to a user in terms of time. For example, as individual audio or video programs are scheduled to be presented during specified time periods, the ESG concerning this information can be organized according to these same time periods, such that information about programs that are about to begin will be presented before programs occurring several hours in the future.

### SUMMARY OF THE INVENTION

Various embodiments provide improved systems and methods for providing ESG information to one or more terminals. According to various embodiments, sliding time windows are used in a hierarchical fashion in order to prioritize file delivery sessions. In this arrangement, file delivery sessions representing a first interval of the hierarchy are extended to cover a longer interval whenever the interval becomes obsolete, i.e., when the end point of the interval becomes a point in the past before the current time. When a session is dropped, a new session is introduced at the end of the hierarchy. Various embodiments also provide a mechanism by which bandwidth can be allocated so that more bandwidth is provided to certain portions of the ESG, such as ESG portions that represent programming which is just about to occur or ESG portions that include a disproportionately large number of ESG fragments.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representation showing the interrelationship among an ESG, service operators, programs, and datacast operators according to various embodiments;

FIG. 2 is a graphical representation of a plurality of ESG sessions including a plurality of programs according to various embodiments, with the time being shortly before 8:30;

FIG. 3 is a graphical representation showing the use of sliding windows relative to FIG. 3, once the time has reached 8:30;

FIG. 4 is a flow chart showing a process by which various embodiments are implemented;

FIG. 5 is a perspective view of an electronic device that can be used in conjunction with the implementation of various embodiments; and

FIG. 6 is a schematic representation of the circuitry which may be included in the electronic device of FIG. 5.

### DETAILED DESCRIPTION OF VARIOUS EMBODIMENTS

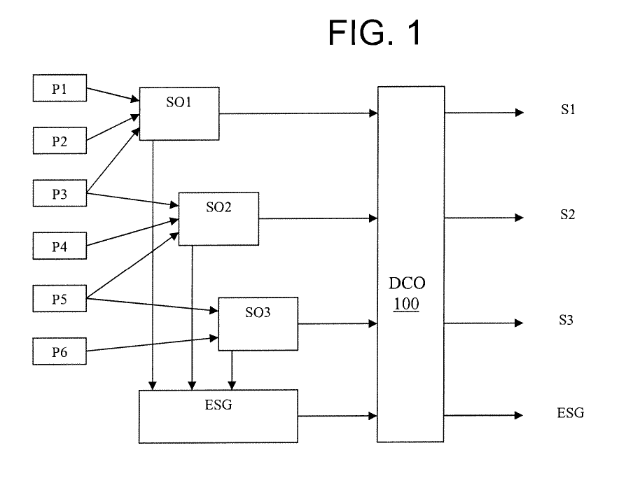

FIG. 1 is a representation showing the interrelationship among an ESG, service operators (SO1, SO2, SO3), programs (P1, P2, P3, P4, P5, P6) and a datacast operator (DCO) 100 according to various embodiments. In this representation, service operators SO1-SO3 provide programs P1-P6 to their consumers or subscribers. In FIG. 1, each service (S1, S2, S3) comprises the programs that may be provided by a particular service operator or by another content provider. It should be noted that some programs may be provided by more than one service operator. The DCO 100 or another type of network operator may be used to transmit programs for service operators which do not have their own transmitting networks.

Each program is associated with data that is used for creating an ESG that is used by the terminal users for selecting programs for consumption. Some of this data, (e.g., program descriptions, duration information, etc.) may originate from the content providers. Other information, such as schedule information, subscription information, may originate from the consumer's service operator. The ESG is sent to terminals as ESG fragments, for example according to the Open Mobile Alliance (OMA) Broadcast (BCAST) Service Guide or the Digital Video Broadcasting (DVB) Internet Protocol Datacast (IPDC) Electronic Service Guide. The OMA BCAST Service Guide is discussed at Service Guide for Mobile Broadcast Services Draft; Version 1.0—4 Jan. 2007; Open Mobile Alliance; OMA-TS-BCAST_ServiceGuide-V1_{—}0_{—}0-20070104-D. The DVB IPDC Electronic Service Guide is discussed at webapp.etsi.org/exchangefolder/ts_{—}102471v010201p.pdf. All of the data relating to the various programs is received by the DCO 100 or other network operator, for example, in an ESG creation module that creates the service guide fragments from the received data and prepares the ESG fragments for transmission to the end users.

Due to the large amounts of data that are often used in conjunction with an ESG, it is desirable to enable terminals to selectively process this data, e.g., in smaller portions. Additionally, and to help efficiently process this data, it is desirable to minimize the number of service guide fragments that represent information about the time intervals that have already occurred. For example, it is helpful to envision a situation where the current time is 8:30 A.M., and the ESG includes two data fragments—one fragment indicating that a first program will be running from 8:30 A.M. to 9:00 A.M. today, and the other fragment indicating that a second program will run from 9:00 A.M. to 10:00 A.M. today. When the time reaches 9:00 A.M., a consumer ordinarily will no longer care about the first program, since it has just ended. Therefore, it is desirable to no longer transmit the first data fragment, since it is likely no longer of interest to the consumer.

In addition to the above, every fragment that is introduced and removed in the ESG results in a change in the delivery structure of the ESG. In other words, with every fragment introduction or removal, information such as the list of fragments being delivered, the addition of the contents for a newly inserted fragment, etc., needs to be updated. It is desirable to keep the number of such changes as low as possible, while still not transmitting information about programs that occurred in the past.

Various embodiments provide improved systems and methods for providing ESG information to one or more terminals. According to various embodiments, sliding time windows are used in a hierarchical fashion in order to prioritize file delivery sessions. In this arrangement, file delivery sessions representing a first interval of the hierarchy are extended to cover a longer interval whenever the interval becomes obsolete, i.e., when the end point of the interval becomes a point in the past before the current time. The end point of the first interval is extended beyond the current time, creating one or more subsequent intervals in the hierarchy. When a session is dropped, a new session is introduced at the end of the hierarchy representing the time interval whose start time equals the end time of the present window and whose length equals the length of the interval of the just dropped session. Various embodiments also provide a mechanism by which bandwidth can be allocated so that more bandwidth is provided to portions of the ESG that are deemed to be more important, such as ESG portions that represent programming which is just about to occur.

The top of a session hierarchy according to various embodiments involve BCAST service guide delivery descriptor (SGDD) time grouping criteria or DVB IPDC indexing, for example. As used herein, “grouping” refers to the division of a set of ESG fragments into subsets of fragments, where each subset represents a certain quality, e.g. with regard to time. In the case of grouping with regard to time, each subset represents a certain time interval. For example, one can have ESG fragments representing the next three hours divided into two subsets with the first subset representing the first two hours and the second subset representing the third hour. In OMA BCAST, such groupings are declared using SGDDs and time grouping criteria. In DVB IPDC, the corresponding structures are indices and sub-indices.

Below the grouping criteria described above in the hierarchy are ESG session details for each session. These session details include information such as delivery IP information, port information, transmitting subscriber identification (TSI) information, etc. This information can be found in OMA BCAST SGDDs and in DBV IPDC “ESG Session Partition Declarations.” The fragment listing can be found in a DescriptorEntry of a SGDD and a sub-index of DVB IPDC indexing.

In terms of obtaining improved bandwidth efficiency, it is desirable to group by forming mutually exhaustive subsets. In such a case, each ESG fragment is both declared and transmitted one time within the ESG. However, it is possible for individual fragments to be transmitted more than once in certain embodiments as necessary or desired. The individual ESG fragments can be transmitted either in-band (e.g., using a broadcast file delivery session such as according the FLUTE protocol or asynchronous layered coding (ALC)) or out-band (e.g., involving an interactive retrieval using HTTP requests).

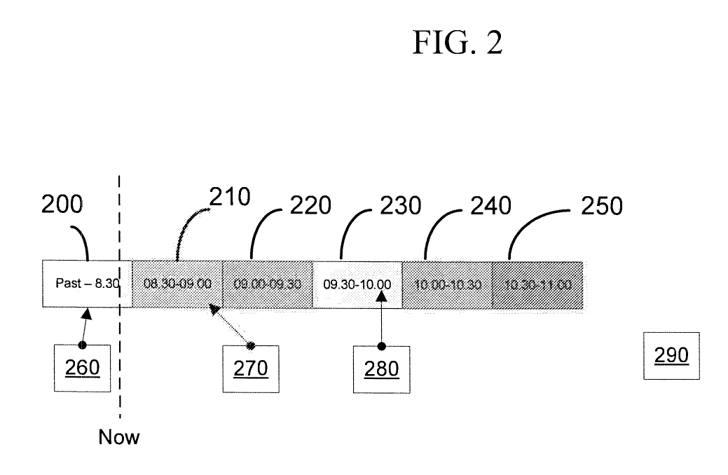

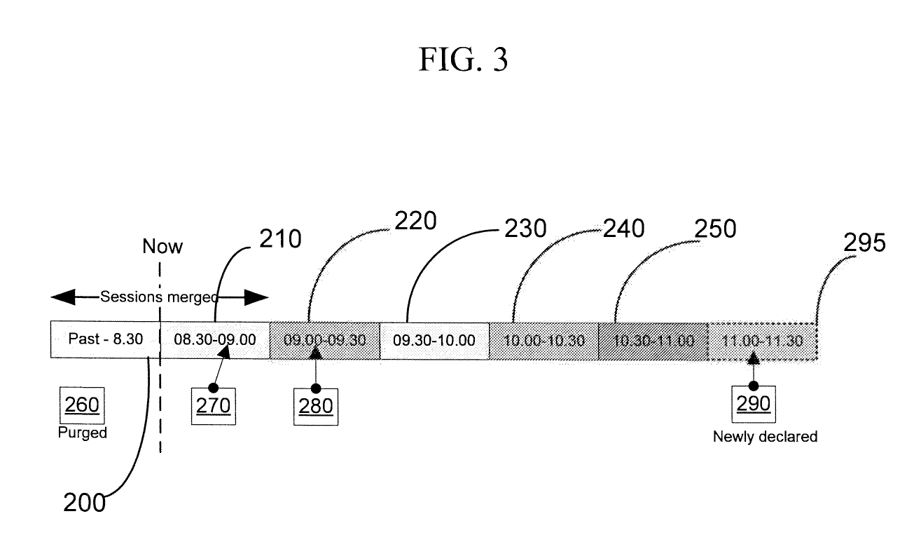

FIGS. 2 and 3 are graphical representations showing the separation of ESG fragments into sessions and the sliding of windows in one implementation. Referring to FIG. 2, a first session 200, a second session 210, a third session 220, a fourth session 230, a fifth session 240 and a sixth session 250 are depicted, each of which constitutes an interval for which there is an ESG session providing program information. In this implementation, the first session 200 includes all data which has been declared in the past which is still valid, for example long programs which have not yet ended. The first session 200 ends at 8:30; the second session 210 runs from 8:30-9:00; the third session 220 runs from 9:00-9:30; the fourth session 230 runs from 9:30-10:00; the fifth session 240 runs from 10:00-10:30; and the sixth session 250 runs from 10:30-11:00. First, second, third and fourth programs are identified at 260, 270, 280 and 290, respectively. In this implementation, it is assumed that the first program 260 runs from 8:15-8:30; the second program 270 runs from 8:30-9:10, the third program 280 runs from 9:10-11:20; and the fourth program 290 runs from 11:20-11:30.

For each program, the start time of the program determines the ESG session to which it belongs. Therefore, the third program 280 belongs to the third session 220, even though it runs through several other sessions as well. In the case of the fourth program 290, this program does not yet belong to any session since there is no ESG session representing sessions after 11:00. As shown in FIG. 2, the current time is shortly before 8:30, meaning that each of the identified programs is either in progress or has yet to begin. It should also be noted that although six sessions are depicted in FIGS. 2 and 3, virtually any number of sessions having various lengths may be used. The setup can also be configured such that the end time of the program determines the ESG session to which the corresponding part of the ESG belongs.

In this example, the division of fragments into separate sessions is based upon end user level program timing represented by the fragment, not the validity of the fragment itself, although it is also possible for fragment validity to be used as the criteria for division. Additionally, it is also noted that the grouping criteria used in this example can be further enhanced by dividing the various subsets into further subsets, for example by considering other fragment characteristics such as fragment type, encoding type, etc.

For the sessions depicted in FIG. 2, the first session 200 will typically have the largest number and most interesting of contents included therein. This is due in part to the fact that the first session 200 is open-ended, going backwards in time to cover all programs which started at any point in the past but are still running. For example, the first session 200 may have several dozen fragments relating to programs that are still in progress yet started one, two or three hours earlier, as well as programs that will be starting just before 8:30. In contrast, the second session 210 only includes programs that are scheduled to start within the specified half-hour interval.

As shown in FIG. 3, when the time reaches 8:30, the first session 200 is merged with the second session 210 in one embodiment and a new session, identified herein as a seventh session 295, is created. Once this action has taken place, the “new” first session covers all programs that are still running from the original first session 200, as well as the programs from the second session. For the seventh session 295, the parameters previously used to establish the second session 210 is used to create the seventh session 295 in the session hierarchy. Only the time interval parameters “start” and “end” (describing the portion of the ESG covered) are re-assigned when the second session is used as the basis for creating the seventh session 295.

In various embodiments, a “cleanup” occurs whenever a hierarchy shift occurs. The cleanup includes, for example, purging program details for programs which have already ended. Referring to FIG. 3, for example, details of the first program 260 can be purged, since the program end time was at 8:30. Additionally, the details for the fourth program 290 are also added to the new seventh session 295, since the start time for this program falls within the time interval for this session (11:00-11:30).

In addition to the above, various embodiments also involve adjusting bandwidth for each session in order to take into account certain specified weightings. These weightings can be based on different criteria. One such criteria is the number of fragments within each session. More specifically, it may be desirable in certain situations to provide more bandwidth to sessions that have more data there within, thereby allowing these large-content sessions to be more quickly transmitted than would otherwise be possible if all sessions were allocated equal bandwidth. For example, it is helpful to consider the following set of six sessions, when there is a total of 100 Kbps of bandwidth available:

TABLE 1

| | | Allocated |
|---|---|---|
| Session | Number of | Bandwidth |
| Number | Fragments | (Kbps) (app.) |
| 1 | 5 | 14.286 |
| 2 | 3 | 8.571 |
| 3 | 4 | 11.428 |
| 4 | 2 | 5.714 |
| 5 | 12 | 34.286 |
| 6 | 3 | 25.714 |
| Total | 35 | 100 |

In this situation, the bitrate for each session can be calculated as

$$( \frac{M\_Sx}{M\_tot} ) * B\_tot = B\_Sx ,$$

where M_Sx is the weight for Session Number X, M_tot is the sum of all M_Sx, B_tot is the total amount of bandwidth allocated for all of the sessions, and B_Sx is the bandwidth reserved from B_tot for Session Number X. Using this formula, the allocated bandwidths provided in Table 1 are determined. This arrangement serves to more efficiently utilize the bandwidth, as bandwidth is not “wasted” on sessions where there is little data to communicate. For example, using this arrangement, more bandwidth is allocated for session 5, which has a relatively large amount of information therein, than for the immediately preceding session 4, which has a much smaller amount of information therein. As a result, the ESG update time for a terminal can be reduced.

In a more detailed implementation of the above concept, weightings can also be applied by session group, in conjunction with individual weightings based upon the number of fragments within each session. In this arrangement, the total bandwidth can first be divided for the desired session groups, and then the bandwidth can be further divided within each group to account for the number of fragments within each session therein. For example, and as discussed previously, a consumer often cares more about programs currently in progress or about to begin than for programs occurring at a later time. Therefore, the sessions identified in Table 1 can be grouped so that more bandwidth is provided for earlier sessions. Referring to Table 1, the first and second sessions can be grouped together in “Group 1” and allocated 50% of the total bandwidth, the third session can be allocated 20% of the bandwidth in a second group, and the remaining, distant sessions can be grouped together in a third group, with the final 30% of bandwidth being divided therebetween. In this situation, the bandwidth allocation for each session can be further defined as

$$W * B\_tot * ( \frac{M\_Sx}{M\_group} ) = B\_Sx .$$

In this formula, W is the relative portion of the total bandwidth allocated for the session group to which x belongs, and M_group is the sum of the weightings for the sessions in the group.

TABLE 2

| | | % of | | Allocated |
|---|---|---|---|---|
| Session | Group | Bandwidth | Number of | Bandwidth |
| Number | Number | for Group | Fragments | (Kbps) (app.) |
| 1 | 1 | 50 | 5 | 31.250 |
| 2 | 1 | 50 | 3 | 18.750 |
| 3 | 2 | 20 | 4 | 20.000 |
| 4 | 3 | 30 | 2 | 2.608 |
| 5 | 3 | 30 | 12 | 15.652 |
| 6 | 3 | 30 | 3 | 11.739 |
| Total | | | 35 | 100 |

Using the above formula, Session 1 would receive (0.50*100)*(5/8)=31.250 Kbps of bandwidth, receiving five eights of the bandwidth allocated to the first group of sessions (including Sessions 1 and 2). Similar calculations can be made for each of the other sessions as well. Weightings can be applied according to other criteria as well, such as the number of bytes in each fragment, and calculations can be performed in a wide variety of manners.

In addition to grouping ESG fragments based upon time, it is also possible for group ESG fragments based upon other criteria, such as with regard to the provider of the service represented by the fragment. This can be helpful since a terminal often needs to use a fragment if and only if the respective end user is affiliated with the service provider at issue. In other words, since a user has less use for fragments relating to services which he or she cannot access, fragments relating to such non-accessible services can be given a smaller amount of bandwidth than fragments relating to services the end user can access. The ESG is usually not per user, but it may in some cases include some fragments that relate to non-accessible services.

During transportation of ESG fragments, it is desirable for each fragment to be declared as few times as possible in order to save both bandwidth and, at the receiving terminal, processing time. In order to accomplish this goal, fragments can be divided into subsets in such a manner that each subset represents a maximum amount of the fragment properties. One method for performing this task involves forming a set “S_all” of all service providers, forming a power set P̂(S_all) of the service providers, examining the members of the power set, beginning with the power set with the most members first, and then associating as many fragments as possible with the member. For a fragment to be eligible for association, the fragment must be affiliated with all of the service operators in the member of the power set at issue. Once a fragment is associated with a member of the service operator power set, the fragment is not considered to be associated with any other member of the power set. Fragments are then both declared (using ESGDDs on OMA-BCAST or in sub-indices of DVB IPDC) and transported according to the above associations. In other words, fragments are placed into transport objects based on the association to the power set, meaning that each container unit contains fragments associated with the same member of the power set of service operators. For transport, service guide delivery units (SGDUs) are used for OMA-BCAST, and containers are used for DVB IPDC. In the case where the affiliation of the fragment is not specifically restricted to any service operators, the fragment is considered to belong to the NULL member of the service operator power set, and the fragment is treated as not belonging to the grouping based on service operator. These sort of fragments are declared and transported outside of service operator groupings in the ESG. As the processing of each fragment and fragment container (SGDU, DVB IPDC or other) takes resources, this arrangement ensures that terminals do not need to process fragments or fragment containers that are not of any use for the terminal, as either all or none of the fragments in a container are affiliated with the terminal.

In various embodiments, fragments are first grouped with regard to time and then further grouped with regard to service operator. However, it is also possible to perform the groupings first with regard to service operator and then with regard to time.

The following is an example showing how a power set can be created and used according to the implementation discussed above. In this example, the set of fragments comprises {F1, F2, F3, F4, F5} and the set of operators comprises {S1, S2 and S3}. The affiliations between the fragments and operators are as follows:

### S1: {F1, F2, F4}

### S2: {F1, F2, F3}

### S3: {F1, F2, F3}

In this case, the associations are as follows:

### { }: {F5}

### {S1}: {F4}

### {S2, S3}: {F3}

### {S1, S2, S3}: {F1, F2}

{S2}, {S3}, {S1, S2} and {S1, S3} are not associated with any fragments, In the transport of OMA-BCAST style fragments, {F1, F2} are placed into their own SGDU, {F5} is placed within its own SGDU, {F4} is placed within its own SGDU, and {F3} is placed within its own SGDU.

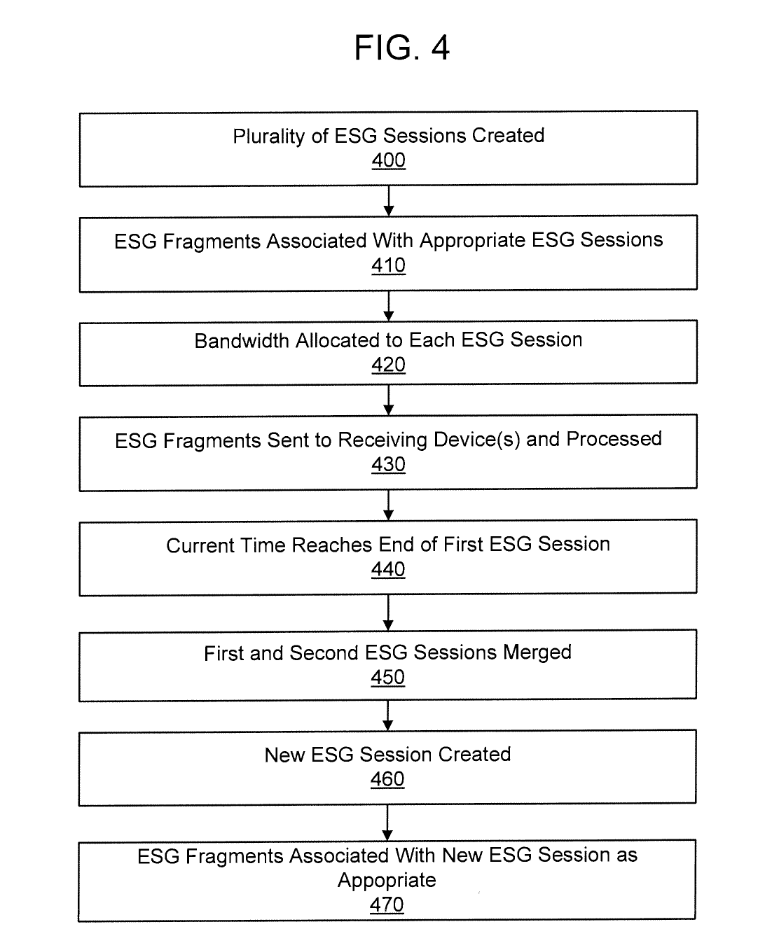

FIG. 4 is a flow chart showing a process by which various embodiments may be implemented. At 400 in FIG. 4, a plurality of ESG sessions are created, each of which is represented by a time interval. As discussed previously, a first ESG session has no fixed start time but a fixed end time, while other ESG sessions include fixed start times and end times. At 410, ESG fragments associated with individual programs are associated with one of the ESG sessions based upon each program's respective start time. At 420 and in certain embodiments, bandwidth is allocated to each session based upon one or more predetermined criteria. As discussed above, these criteria may include the number of fragments associated with each session, the relative importance of each session, etc. At 430, the ESG fragments are sent to one or more receiving devices using the allocated bandwidths of the respective ESG sessions, and the receiving devices process the fragments accordingly. The fragments can be sent, for example, in groupings of the type discussed above. At 430, the current time reaches the point at which the first ESG session is entirely in the past. At this point, the first and second sessions 200 and 210 are merged together at 440, and a new session is created at 450. At 460, ESG fragments associated with any programs that occur within the new session are associated therewith.

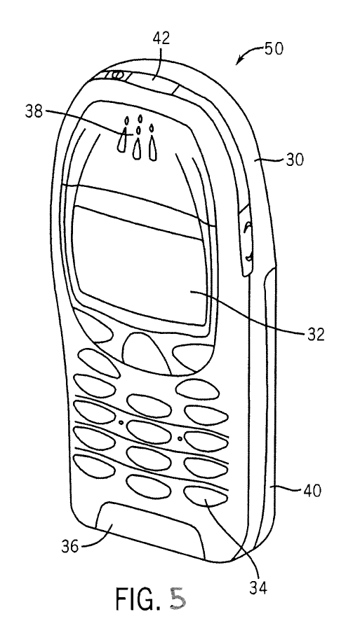

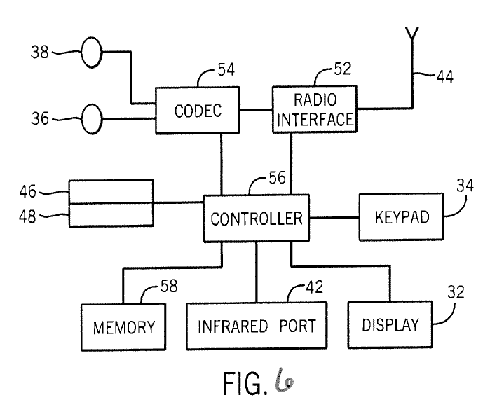

FIGS. 5 and 6 show one representative electronic device 50 within which various embodiments may be implemented. It should be understood, however, that the various embodiments are not intended to be limited to one particular type of device. The electronic device 50 of FIGS. 5 and 6 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. Individual circuits and elements are all of a type well known in the art, for example in the Nokia range of mobile telephones.

Communication devices discussed herein may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments may communicate using various media including, but not limited to, radio, infrared, laser, cable connection, and the like.

The various embodiments described herein are described in the general context of method steps or processes, which may be implemented in one embodiment by a computer program product, embodied in a computer-readable medium, including computer-executable instructions, such as program code, executed by computers in networked environments. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Individual and specific structures described in the foregoing examples should be understood as constituting representative structure of means for performing specific functions described in the following the claims, although limitations in the claims should not be interpreted as constituting “means plus function” limitations in the event that the term “means” is not used therein. Additionally, the use of the term “step” in the foregoing description should not be used to construe any specific limitation in the claims as constituting a “step plus function” limitation.

Software and web implementations of various embodiments can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

The foregoing description of embodiments have been presented for purposes of illustration and description. The foregoing description is not intended to be exhaustive or to limit embodiments to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated.

1-27. (canceled)

28. A method comprising:
associating each of a plurality of electronic service guide fragments with one of a plurality of electronic service guide sessions, each representing a specified time frame;
determining whether a first one of the electronic service guide session is in a past time period; and
based on the determination, causing, at least in part, merging the first electronic service guide session with a second one of the electronic service guide sessions that occurs in a next time period.

29. A method of claim 28, wherein the association is based upon a start time, an end time, or both of a program associated with the respective electronic service guide fragment.

30. A method of claim 28, further comprising:
selectively allocating available bandwidth to each electronic service guide session; and
causing, at least in part, transmission of each of the plurality of electronic service guide fragments to at least one receiving device in accordance with the allocated bandwidth.

31. A method of claim 30, wherein the available bandwidth is allocated to each electronic service guide session based at least in part on a number of the electronic service guide fragments within each electronic service guide session, a total number of bytes of data for the electronic service guide fragments within each electronic service guide session, a proximity of the specified time frame for each electronic service guide session to the current time, or a combination thereof.

32. A method of claim 30, wherein the available bandwidth is allocated to each electronic service guide session based at least in part on whether an intended recipient of the electronic service guide fragments within the respective electronic service guide session is affiliated with a service provider that provided the respective electronic service guide fragments.

33. A method of claim 28, wherein a beginning time of the time frame in the first electronic service guide session is not defined.

34. A method of claim 28, further comprising:
dividing the plurality of electronic service guide fragments into a plurality of subsets such that each subset represents a maximum amount of electronic service guide fragment properties; and
causing, at least in part, actions that result in transmission of the plurality of subsets to at least one receiving station.

35. An apparatus comprising:
at least one processor; and
at least one memory including computer program code,
the at least one memory and the computer program code configured to, with the at least one processor, cause the apparatus to perform at least the following,
associate each of a plurality of electronic service guide fragments with one of a plurality of electronic service guide sessions, each representing a specified time frame;
determine whether a first one of the electronic service guide session is in a past time period; and
based on the determination, merge the first electronic service guide session with a second one of the electronic service guide sessions that occurs in a next time period.

36. An apparatus of claim 35, wherein the association is based upon a start time, an end time, or both of a program associated with the respective electronic service guide fragment.

37. An apparatus of claim 35, wherein the apparatus is further caused to:
selectively allocate available bandwidth to each electronic service guide session; and
cause, at least in part, actions that result in transmission of each of the plurality of electronic service guide fragments to at least one receiving device in accordance with the allocated bandwidth.

38. An apparatus of claim 37, wherein the available bandwidth is allocated to each electronic service guide session based at least in part on a number of the electronic service guide fragments within each electronic service guide session, a total number of bytes of data for the electronic service guide fragments within each electronic service guide session, a proximity of the specified time frame for each electronic service guide session to the current time, or a combination thereof.

39. An apparatus of claim 37, wherein the available bandwidth is allocated to each electronic service guide session based at least in part on whether an intended recipient of the electronic service guide fragments within the respective electronic service guide session is affiliated with a service provider that provided the respective electronic service guide fragments.

40. An apparatus of claim 35, wherein a beginning time of the time frame in the first electronic service guide session is not defined.

41. An apparatus of claim 40, wherein the apparatus is further caused to:
divide the plurality of electronic service guide fragments into a plurality of subsets such that each subset represents a maximum amount of electronic service guide fragment properties; and
cause, at least in part, actions that result in transmission of the plurality of subsets to at least one receiving station.

42. A computer-readable storage medium carrying one or more sequences of one or more instructions which, when executed by one or more processors, cause an apparatus to at least perform the following steps:
associating each of a plurality of electronic service guide fragments with one of a plurality of electronic service guide sessions, each representing a specified time frame;
determining whether a first one of the electronic service guide session is in a past time period; and
based on the determination, causing, at least in part, merging the first electronic service guide session with a second one of the electronic service guide session that occurs in a next time period.

43. A computer readable storage medium of claim 42, wherein the association is based upon a start time, an end time, or both of a program associated with the respective electronic service guide fragment.

44. A computer readable storage medium of claim 42, wherein the apparatus is further caused to perform:
selectively allocating available bandwidth to each electronic service guide session; and
causing, at least in part, actions that result in transmission of each of the plurality of electronic service guide fragments to at least one receiving device in accordance with the allocated bandwidth.

45. A computer readable storage medium of claim 44, wherein the available bandwidth is allocated to each electronic service guide session based at least in part on a number of the electronic service guide fragments within each electronic service guide session, a total number of bytes of data for the electronic service guide fragments within each electronic service guide session, a proximity of the specified time frame for each electronic service guide session to the current time, whether an intended recipient of the electronic service guide fragments within the respective electronic service guide session is affiliated with a service provider that provided the respective electronic service guide fragments, or a combination thereof.

46. A computer readable storage medium of claim 42, wherein a beginning time of the time frame in the first electronic service guide session is not defined.

47. A computer readable storage medium of claim 44, wherein the apparatus is further caused to perform:
dividing the plurality of electronic service guide fragments into a plurality of subsets such that each subset represents a maximum amount of electronic service guide fragment properties; and
causing, at least in part, actions that result in transmission of the plurality of subsets to at least one receiving station.
